(19) United States
(12) Patent Application Publication
(10) Pub. No.: US 2026/0304288 A1
(43) Pub. Date: Oct. 1, 2026

(54) ENABLING RAN TRAFFIC DISCARD NOTIFICATIONS

(71) Applicant: InterDigital Patent Holdings, Inc., Wilmington, DE (US)

(72) Inventors: Magurawalage Chathura Madhusanka SARATHCHANDRA, London (GB); Michael STARSINIC, Newtown, PA (US); Rocco DI GIROLAMO, Laval (CA); Michel ROY, Candiac (CA); Xavier DE FOY, Kirkland (CA); Srinivas GUDUMASU, Montreal (CA); Ahmed HAMZA, Coquitlam (CA); Francois PERIARD, Montreal (CA); Kevin DI LALLO, Laval (CA)

(73) Assignee: InterDigital Patent Holdings, Inc., Wilmington, DE (US)

(21) Appl. No.: 19/092,736

(22) Filed: Mar. 27, 2025

(51) Int. Cl. H04W 40/24; H04L 1/00; H04L 47/32; H04L 47/56; H04W 40/12

(52) U.S. Cl. CPC H04W 40/246; H04L 1/004; H04L 47/32; H04L 47/56; H04W 40/12

(57) ABSTRACT

In some implementations, a RAN node may include receiving, a monitoring request configuration identifying one or more respective data flows requiring a traffic notification indicating a PDU or a delayed PDU. In addition, the RAN node may include identifying one or more dropped PDUs or one or more delayed PDUs corresponding to the one or more respective data flows. The RAN node may include sending, to a first network element, a traffic notification message indicating the one or more dropped PDUs detected or the one or more delayed PDUs detected. The monitoring request configuration may include a delay threshold value for detecting the one or more dropped PDUs or the one or more delayed PDUs, a reporting period for sending the traffic notification message, or one or more traffic notification message information fields to be included in the traffic notification message.

### BACKGROUND

End-to-End (E2E) rate represents the actual throughput users experience. E2E rate is the speed at which data can be transmitted from one device to another across the entire network, encompassing the radio access network (RAN), transport network, and core network considering the radio access network (RAN), transport network, and core network. A high E2E rate is crucial or supporting various 5G use cases, including ultra-reliable low-latency communications (URLLC), massive machine-type communications (mMTC), and enhanced mobile broadband (eMBB). When network data is dropped or delayed, a network component may attempt to retransmit the dropped or delayed data. Modern wireless communication networks employ techniques to retransmit dropped or delay date efficiently to achieve ultra-reliable low-latency communications.

Current techniques, however, fail to adequately monitor packet data units (PDUs) that may be dropped or delayed by a RAN node or even sent to a UE/WTRU. Thus, the need exists for a technological solution enabling a network component, for example a network function or application server, to detect PDUs that were discarded or delayed.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include receiving a monitoring request configuration identifying one or more respective data flows requiring a traffic notification indicating a dropped packet data unit (PDU) or a delayed PDU. The method may also include identifying one or more dropped PDUs or one or more delayed PDUs corresponding to the one or more respective data flows. The method may furthermore include sending, to a first network element, a traffic notification message indicating the one or more dropped PDUs detected or the one or more delayed PDUs detected. Other embodiments of this aspect include corresponding computer systems, apparatus, and computer programs recorded on one or more computer storage devices, each configured to perform the actions of the methods.

Implementations may include one or more of the following features. The method where the monitoring request configuration further may include at least one of: a delay threshold value for identifying the one or more dropped PDUs or the one or more delayed PDUs, where the delay threshold value is time value equal to or greater than zero; a reporting period for sending the traffic notification message; or one or more traffic notification message information fields to be included in the traffic notification message. The method where the one or more traffic notification message information fields may include at least one of: PDU information indicating the one or more dropped PDUs or the one or more delayed PDUs, a cause value corresponding to the respective one or more dropped PDUs or the one or more delayed PDUs, a protocol for sending the traffic notification message, a first network element identification, or a second element identification. The method where the monitoring request configuration further may include at least one of: a packet delay budget (PDB), or a PDU set delay budget (PSDB). The method where the PDU information may include at least one of: an indication of how long delivery of each PDU of the one or more dropped PDUs or one or more delayed PDUs was delayed beyond the PDB; or an indication of how long delivery of a respective PDU of the one or more dropped PDUs or one or more delayed PDUs or a respective PDU set of the one or more dropped PDUs or one or more delayed PDUs was delayed beyond the PSDB. The method where identifying the one or more dropped PDUs or the one or more delayed PDUs is based on a determined cause, the determined cause having at least one of: determining a respective PDU cannot be delivered within the PDB; determining a respective PDU or a respective PDU set cannot be delivered within the PSDB; determining, with a PDU set integrated handling indication (PSIHI) is enabled, that a PDU of a same PDU set has been discarded; determining that a PDU of a same PDU set has been discarded and discarding the PDU will not decrease a PDU set error rate (PSER) of the same PDU; determining, based on an application layer forward error correction (AL-FEC) PDU set discard ratio, a PDU can be discarded because enough PDUs of a same PDU set have been delivered; determining to transmit a PDU knowing the PDU cannot be delivered within the PDB; determining to transmit a PDU knowing the PDU set the PDU belongs to cannot be delivered within the PSDB; determining to transmit a PDU while PSHI is enabled knowing a PDU of a same PDU set has been discarded; determining to transmit a PDU knowing, based on an AL-FEC PDU Set Discard Ratio, that a PDU is discarded because enough PDUs of a same PDU set have been delivered; or determining to drop a PDU based on congestion at the RAN. The method where the cause value corresponds to the determined cause. The method where the monitoring request configuration further may include at least one of: a respective priority of one or more PDUs associated with the one or more respective data flows; a respective priority of a PDU set having the one or more PDUs associated with the one or more respective data flows; a quality of service (QoS) flow of one or more PDUs associated with the one or more respective data flows; and a service data flow (SDF) of one or more PDUs associated with the one or more respective data flows; or a multiplexed stream of one or more PDUs associated with the one or more respective data flows. The method may include: determining to send the traffic notification message indicating the one or more dropped PDUs identified or the one or more delayed PDUs identified based on at least one of: the respective priority of the of one or more PDUs associated with the one or more respective data flows; the respective priority of the PDU set having the one or more PDUs associated with the one or more respective data flows; the QoS flow of the one or more PDUs associated with the one or more respective data flows; the SDF of the one or more PDUs associated with the one or more respective data flows; or the multiplexed stream of the one or more PDUs associated with the one or more respective data flows. Implementations of the described techniques may include hardware, a method or process, or a computer tangible medium.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an exemplary procedure of traffic discard or delay notifications; and

FIG. 3 is a flow diagram of an example process for detecting and reporting dropped or delayed PDU.

### DETAILED DESCRIPTION

### Abbreviations and Acronyms

5GSM 5G Session Management
ACK Acknowledgement
AF Application Function
AS Application Server
AMF Access and Mobility Management Function
AN Access Network
BS Base Station
CDRX Connected Mode Discontinuous Reception
CL Classifier
CM Connection Management
DN Data Network
DNAI Data Network Access Identifier
EoB End of Burst
PCC Policy and Charging Control
PDU Protocol Data Unit
PSA PDU Session Anchor
QoE Quality of Experience
QoS Quality of Service
RAN Radio Access Network
SMF Session Management Function
SDF Service Data Flow
SSC Session and Service Continuity
SSCMSP SSC mode selection policy
TSC Time-sensitive communications
TSN Time-sensitive networking
TTL Time To Live
UL Uplink
UPF User Plane Function
UE User Equipment
URLLC Ultra-Reliable and Low Latency Communications
ISF Integrated Sensing Function

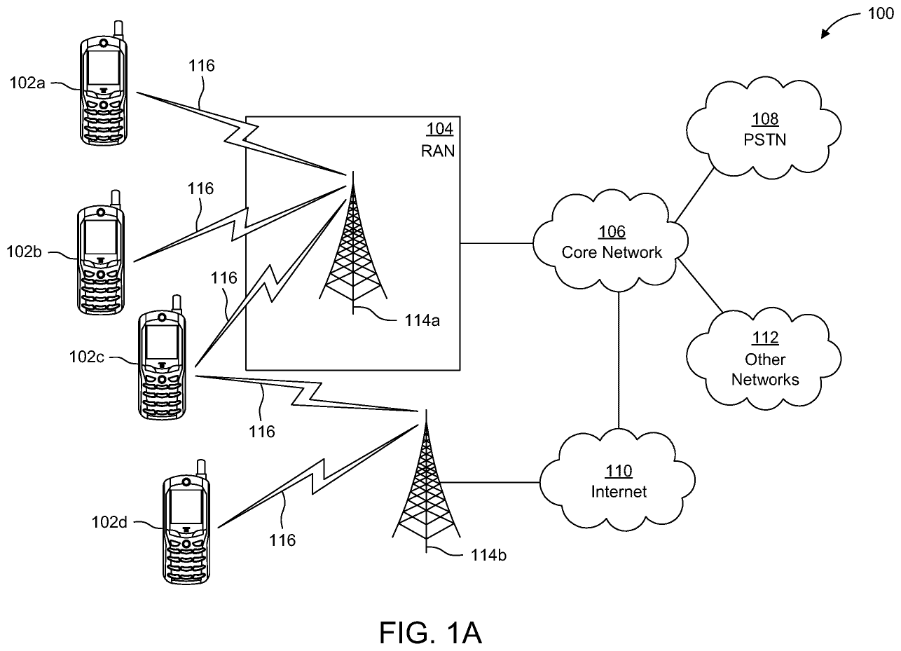

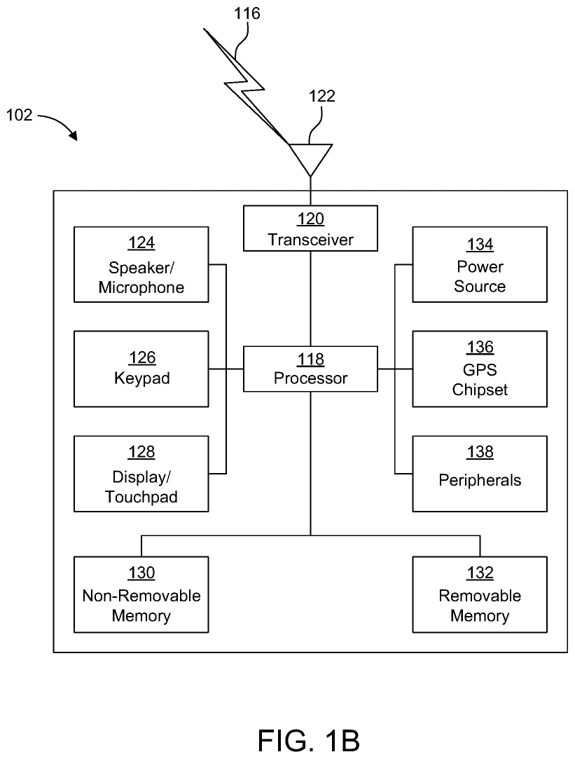

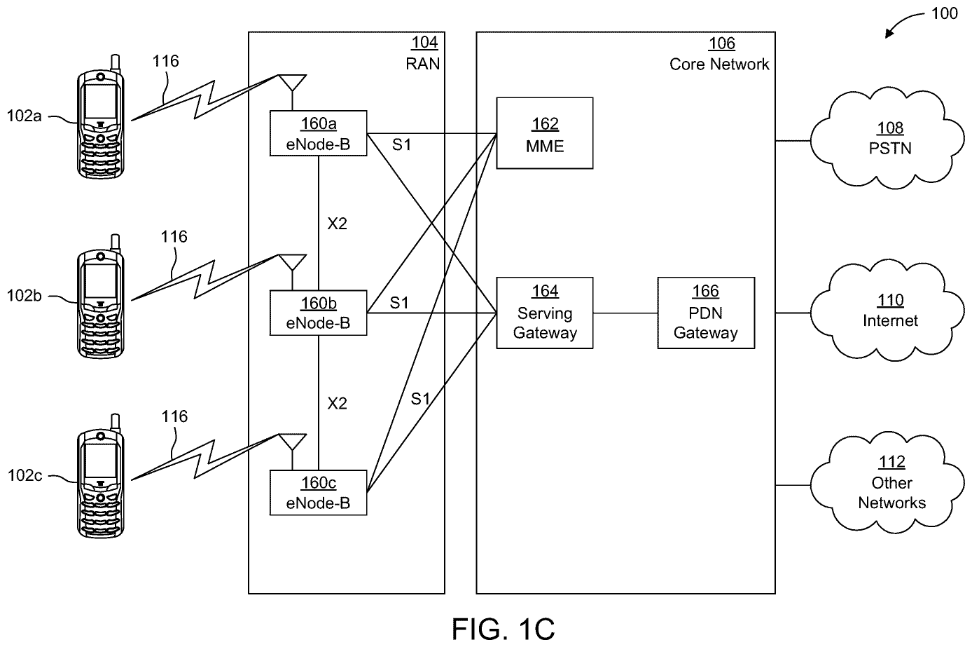

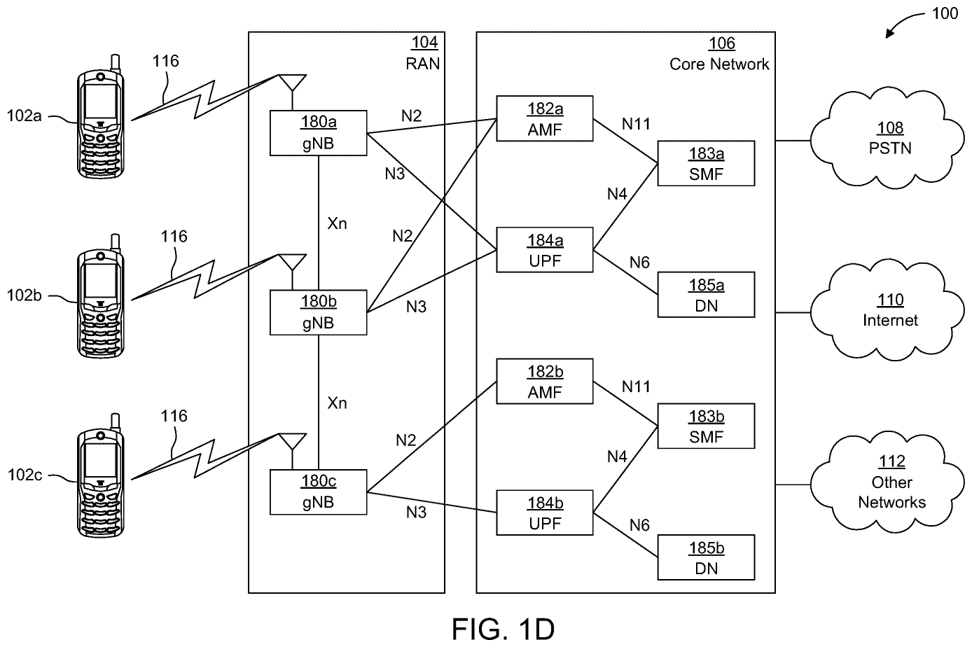

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In an example embodiment, a RAN node may be configured to receive a QoS Monitoring Request message from a session management function (SMF) requesting traffic discard/delay notifications. For example, an application function (AF) or application server (AS) may request, via NE, traffic discard reports at the RAN node. The SMF may determine that traffic discard notifications must be enabled at the RAN. The SMF may also determine what to include in the notification, when to send the notification and where to send the notification. The RAN node may detect that traffic is dropped or delayed, and based on a configured received from SMF, the RAN node may decide to send a traffic discard notification to UPF over GTP-U with information about the detected traffic discard or a delay event. The RAN node may send a traffic discard notification to UPF, based on the configuration received and the traffic discard notification may contain information of the traffic discard or delay event. For example, it may specify that the cause of the discard event was due to congestion.

It is expected that 3GPP Rel-20 , SA2 studies may include: further improvements on user datagram protocol (UDP) and quick UDP internet connection (QUIC) aware proxying using HTTP, enhancements to PDU Set and other media related information-based traffic handling, enhancement to support application layer forward error correction (AL-FEC) awareness at RAN, network capability openness, enhancements to XR/media delivery, and how to avoid/compensate E2E rate impact at the AS based on feedback that PDU sets are dropped or delayed.

Enhancement to support AL-FEC awareness at RAN and indicates a need for a mechanism for application to be informed about why packets are discarded at the RAN and enhancements to XR/media delivery, and how to avoid/compensate E2E rate impact at the AS based on feedback that PDU sets are dropped or delayed require a mechanism for application to be informed about why packets are discarded at the RAN.

For example, IETF RFC 5725, “Post-Repair Loss RLE Report Block Type for RTP Control Protocol (RTCP) Extended Reports” conveys information regarding the individual Real-time Transport Protocol (RTP) packet receipt and loss events experienced during the RTCP interval preceding the transmission of the report. Moreover, this report carries information regarding the packets that remain lost after all loss-repair methods are applied, and lacks information on why a RAN node may discard or delay packets.

There are no mechanisms in the 5G system (5GS) for the application server (AS) to detect why a PDU(s) were discarded by the network or delayed in the network. In the Rel-19 system, downlink PDUs might be discarded by the RAN node or may be sent to the UE/WTRU even in cases where the RAN Node detects that delivery of the PDU will not fulfill the QoS requirements of the QoS Flow. For example a RAN Node may determine to discard a PDU because a QoS Requirement cannot be met or because of a congestion situation in the network.

A WTRU may detect that PDUs were “lost” in the network. The WTRU may or may not detect that some PDUs arrive late. In cases where the discarded PDUs are a result of a RAN decision, the AS may interpret the discarded PDUs as lost PDUs and may try to compensate for the lost PDUs.

Similarly application layer protocols that are used between the WTRU and AS to allow the WTRU to indicate to the AS whether PDUs are successfully received and may also allow the WTRU to indicate whether a PDU was received “on time.”

However, there are no mechanisms in the 5GS to enable the AS to detect why PDU(s) were discarded by the network or delayed in the network.

Procedures described herein present mechanisms in the 5GS to enable an application server or a network function to detect why PDU(s) were discarded by the network or delayed in the network. This is achieved through enabling RAN node send discard or delay notifications to AF/AS.

Throughout the description, the notifications sent by RAN may be referred to as “discard notifications” but the same notifications may be use for sending traffic delay notifications. In addition, throughout this description, “traffic discard notification” may be referred to as “traffic notification.”

The following describes information that may be included in the notifications that are sent from the RAN, for discarded or delayed traffic.

A RAN Node may send a traffic discard notification, and the traffic discard notification may include information about packets that are dropped or discarded. The traffic discard notification may indicate a drop or delay cause value. Following are examples of drop or delay cause values that may be provided in the notification.

The RAN Node determined that the PDU cannot be delivered to the WTRU within the PDB. The RAN Node determined that the PDU Set that the PDU belongs to cannot be delivered to the WTRU within the PSDB.

PDU Set Integrated Handling Indication (PSIHI) is enabled and the RAN Node determined that another PDU of the same PDU Set has been discarded.

The RAN Node determined that another PDU of the same PDU Set has been discarded and discarding the PDU will not decrease the PDU set error rate (PSER).

The RAN Node determined, based on an AL-FEC PDU Set Discard Ratio, that the PDU can be discarded because enough PDUs of the same PDU set have already been delivered to the WTRU for the WTRU to recover the information that was used to create the PDU Set.

The RAN Node may transmit a PDU although the RAN Node determined that the PDU cannot be delivered to the WTRU within the PDB. (i.e., the RAN node may deliver the PDU late)

The RAN Node may transmit a PDU although the RAN Node determined that the PDU Set that the PDU belongs to cannot be delivered to the WTRU within the PSDB. (i.e., the RAN node may deliver the PDU Set late).

The RAN Node may transmit a PDU although the PSIH is enabled and the RAN Node determined that another PDU of the same PDU Set has been discarded. (i.e., the RAN node may deliver the PDU although the WTRU might not be able to use it).

The RAN Node may transmit a PDU although the RAN Node determined, based on an AL-FEC PDU Set Discard Ratio, that the PDU could have been discard because enough PDUs of the same PDU set have already been delivered to the WTRU for the WTRU to recover the information that was used to create the PDU Set.

The RAN Node may have determined to drop a packet because of a congestion situation in the RAN Node.

The traffic discard notification or traffic notification may indicate how long delivery of each PDU was delayed beyond a PDB.

The traffic discard notification may indicate how long delivery of a PDU Set was delayed beyond a PSDB. The network (e.g. SMF or AMF) may configure traffic discard notification for a RAN node. The configuration may include information on when to send the notification: traffic notification message.

When to send the notification may include to send a notification for every dropped PDU or every delayed PDU. To send a notification when then number of dropped PDUs or delayed PDUs passes a threshold. The RAN node may additionally be configured with the periodicity of the notifications. To send a notification periodically. The RAN node may additionally be configured with the periodicity of the notifications.

When to send the notification may include to send a notification for select dropped PDUs or select delayed PDUs. The determination of the selected PDUs may be based on the priority of the PDU, the priority of the PDU Set to which the PDU belongs, the QoS flow to which the PDU belongs, the SDF to which the PDU belongs, the multiplexed stream to which the PDU belongs, etc. In addition, the determination of the selected PDUs may be based on an indication carried on the PDU header. For example, a notification is sent only if the PDU that carries this indication is discarded or delayed.

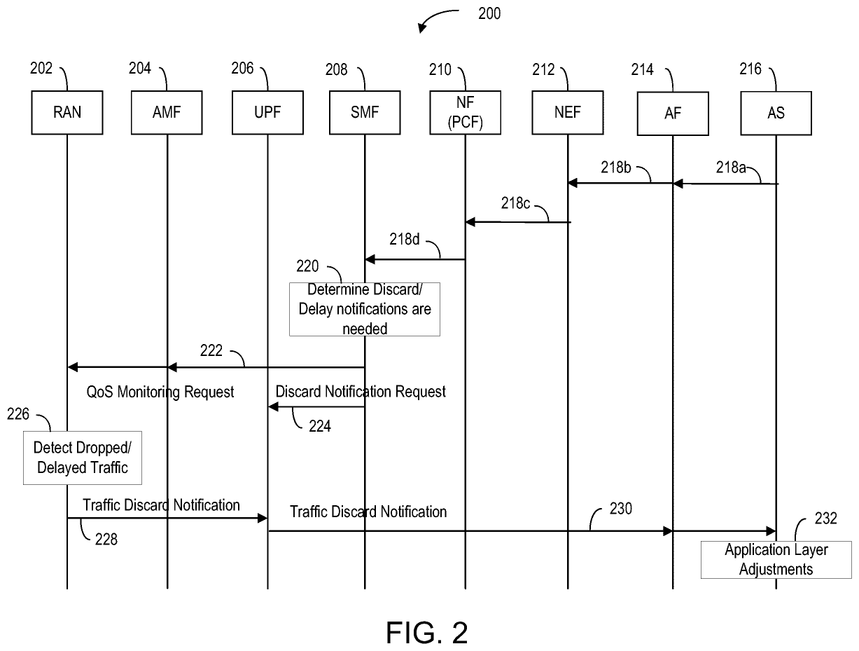

FIG. 2 illustrates an exemplary procedure of traffic discard or delay notifications. It should be understood that “traffic discard notification” may refer to dropped traffic of a dropped packet data unit (PDU), and “delay notifications” may refer to delayed traffic or a delayed PDU.

The procedures below enable a RAN node to provide information the core network (CN) about any dropped or delayed packets.

At 220, SMF 208 determines that traffic discard notifications must be enabled at the RAN. This may be based on any of the following triggers.

A message (218d) from NF 210 (such as the PCF) may trigger SMF 208 to determine that traffic discard notifications must be enabled at the RAN. For example, AF 214 may request (218b) via NEF 212 for traffic discard reports at the RAN or AS 216 may request (218a) via NEF 212 for traffic discard reports at the RAN. NEF 212, may forward the request (218c) to SMF 208.

Although not shown, a request from a WTRU in a PDU session establishment/modification may trigger may also trigger SMF 208 to determine that traffic discard notifications must be enabled at the RAN.

At 222, SMF 208 sends a QoS monitoring request to RAN node 202, requesting traffic discard notifications from the RAN, for indicated service data flows (SDFs) or quality of service (QoS) flows.

The QoS Monitoring Request, may also referred to as monitoring request configuration. This message may indicate when to send the notifications. For example, it may indicate that the notifications should be sent only after traffic discarding or delaying exceeds a certain threshold. The message may indicate that the notifications should be sent periodically, and the message may indicate a preferred time period between notifications. For example, the message may indicate that RAN node 202 should send a report every 5 seconds and that the report should summarize the discard events that took place over the past 5 seconds.

This message may indicate how to send the notifications. For example, the message may indicate that the notification may be sent over the user plane, using GTP-U fields, UPF 206. Moreover, it may indicate the type of GTP-U fields to be used. In another example, it may indicate that the notification may be sent over the control plane (via NEF).

This message may indicate what information to be included in the notification as described above.

This message may indicate that a single notification may include information of more than one dropped or delayed data/event (e.g., through sampling).

At 224, SMF 208 may send a discard notification request to UPF 206. This message indicates how it will receive discard or delay notifications from RAN node 202. For example, it may indicate that the notifications will be received over GTP-U. Moreover, this message may indicate what information of traffic will be sent by RAN node 202, and the fields that should be used may be required.

This message may indicate what UPF 206 may do once a notification is received from RAN node 202. For example, the message may indicate that the notification and information in the notification is to be sent directly to AS 215 or to AF 214 via NEF 212. The message may include an identity of NEF 212 and a transaction identifier that NEF 212 can map to an AF identifier. The transaction identifier can be included in reports that UPF 206 sends to NEF 212 and NEF 212 may use the transaction identifier to determine what AF the information should be sent to. The message may include an IP Address and Port Number of AS 216 that UPF 206 should send the report to.

At 226, RAN node 202 detects that traffic is dropped or delayed. Based on the configuration received 222, RAN node 202 may determine what actions must be taken.

RAN 202 node may decide to send a traffic discard notification UPF 206 over GTP-U with any combination of information described above beginning in paragraph [0077].

At 228, RAN node 202 sends a traffic discard notification UPF 206, based on the configuration received at 222, and may contain any combination of information above beginning in paragraph [0077].

Information in this notification may include an already occurred event (e.g., dropped PDU, delayed PDU), an ongoing or a continuous event (e.g., start of continuous/ongoing PDU delay event, end of continuous PDU delay event/connection recovered).

At 230, UPF 206, upon receiving a discard notification (228) from RAN node 202, determines to send information from the traffic discard notification to AF 214 via NEF 212 or to AS 216. This message may include any combination of information described above beginning in paragraph [0077].

At 232, AS 216 performs application layer adjustments, based on traffic discard notifications it received from the 5G system. Examples of such application layer adjustments include the following: determines to change the encoding of the application layer data (e.g. decides to lower the quality of a video stream to account for poor network performance); determine to change rendering quality (e.g., of objects or some items), for example, this may allow the application to compensate overall delay with rendering time; and determines to change an AL-FEC code rate (e.g. decides to decrease the amount of FEC that is applied to application layer to account for good network performance)

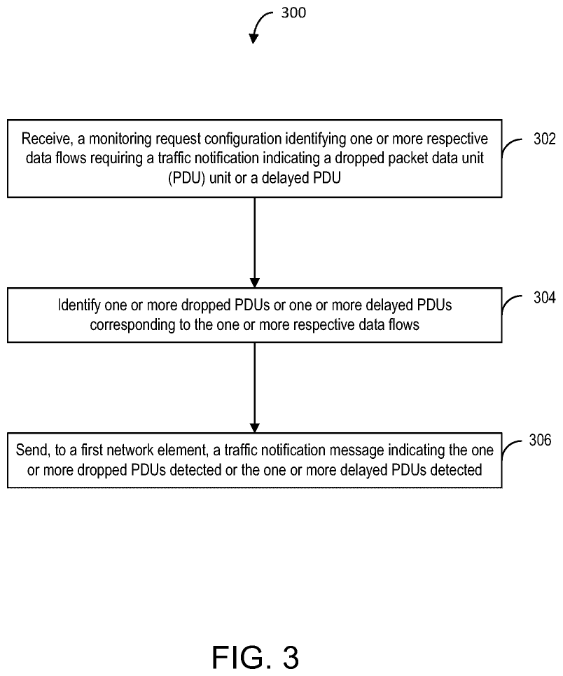

FIG. 3 is a flow diagram of an example process 300 for detecting and reporting dropped or delayed PDU. In some implementations, one or more process blocks of FIG. 3 may be performed by a RAN node.

As shown in FIG. 3, process 300 may include, at 302, receiving a monitoring request configuration identifying one or more respective data flows requiring a traffic notification indicating a dropped packet data unit (PDU) or a delayed PDU. For example, RAN node may receive, a monitoring request configuration identifying one or more respective data flows requiring a traffic notification indicating a dropped PDU or a delayed PDU, as described above. As also shown in FIG. 3, process 300 may include, at 304, identifying one or more dropped PDUs or one or more delayed PDUs corresponding to the one or more respective data flows. For example, RAN node may identify one or more dropped PDUs or one or more delayed PDUs corresponding to the one or more respective data flows, as described above. As further shown in FIG. 3, process 300 may include, at 306, sending, to a first network element, a traffic notification message indicating the one or more dropped PDUs detected or the one or more delayed PDUs detected. For example, RAN node may send, to a first network element, a traffic notification message indicating the one or more dropped PDUs detected or the one or more delayed PDUs detected, as described above.

Process 300 may include additional implementations, such as any single implementation or any combination of implementations described below and/or in connection with one or more other processes described elsewhere herein. In a first implementation, the monitoring request configuration further may include at least one of: a delay threshold value for identifying the one or more dropped PDUs or the one or more delayed PDUs, where the delay threshold value is time value equal to or greater than zero; a reporting period for sending the traffic notification message; or one or more traffic notification message information fields to be included in the traffic notification message.

In a second implementation, alone or in combination with the first implementation, the one or more traffic notification message information fields may include at least one of: PDU information indicating the one or more dropped PDUs or the one or more delayed PDUs, a cause value corresponding to the respective one or more dropped PDUs or the one or more delayed PDUs, a protocol for sending the traffic notification message, a first network element identification, or a second element identification.

In a third implementation, alone or in combination with the first and second implementation, the monitoring request configuration further may include at least one of: a packet delay budget (PDB), or a PDU set delay budget (PSDB).

In a fourth implementation, alone or in combination with one or more of the first through third implementations, the PDU information may include at least one of: an indication of how long delivery of each PDU of the one or more dropped PDUs or one or more delayed PDUs was delayed beyond the PDB; or an indication of how long delivery of a respective PDU of the one or more dropped PDUs or one or more delayed PDUs or a respective PDU set of the one or more dropped PDUs or one or more delayed PDUs was delayed beyond the PSDB.

In a fifth implementation, alone or in combination with one or more of the first through fourth implementations, identifying the one or more dropped PDUs or the one or more delayed PDUs is based on a determined cause, the determined cause having at least one of: determining a respective PDU cannot be delivered within the PDB; determining a respective PDU or a respective PDU set cannot be delivered within the PSDB; determining, with a PDU set integrated handling indication (PSIHI) is enabled, that a PDU of a same PDU set has been discarded; determining that a PDU of a same PDU set has been discarded and discarding the PDU will not decrease a PDU set error rate (PSER) of the same PDU; determining, based on an application layer forward error correction (AL-FEC) PDU set discard ratio, a PDU can be discarded because enough PDUs of a same PDU set have been delivered; determining to transmit a PDU knowing the PDU cannot be delivered within the PDB; determining to transmit a PDU knowing the PDU set the PDU belongs to cannot be delivered within the PSDB; determining to transmit a PDU while PSHI is enabled knowing a PDU of a same PDU set has been discarded; determining to transmit a PDU knowing, based on an AL-FEC PDU Set Discard Ratio, that a PDU is discarded because enough PDUs of a same PDU set have been delivered; or determining to drop a PDU based on congestion at the RAN.

In a sixth implementation, alone or in combination with one or more of the first through fifth implementations, the cause value corresponds to the determined cause.

In a seventh implementation, alone or in combination with one or more of the first through sixth implementations, the monitoring request configuration further may include at least one of: a respective priority of one or more PDUs associated with the one or more respective data flows; a respective priority of a PDU set having the one or more PDUs associated with the one or more respective data flows; a quality of service (QoS) flow of one or more PDUs associated with the one or more respective data flows; and a service data flow (SDF) of one or more PDUs associated with the one or more respective data flows; or a multiplexed stream of one or more PDUs associated with the one or more respective data flows.

An eighth implementation, alone or in combination with one or more of the first through seventh implementations, process 300 further includes determining to send the traffic notification message indicating the one or more dropped PDUs identified or the one or more delayed PDUs identified based on at least one of: the respective priority of the of one or more PDUs associated with the one or more respective data flows; the respective priority of the PDU set having the one or more PDUs associated with the one or more respective data flows; the QoS flow of the one or more PDUs associated with the one or more respective data flows; the SDF of the one or more PDUs associated with the one or more respective data flows; or the multiplexed stream of the one or more PDUs associated with the one or more respective data flows.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a radio access node (RAN), the method comprising:
receiving a monitoring request configuration identifying one or more respective data flows requiring a traffic notification indicating a dropped packet data unit (PDU) or a delayed PDU;
identifying one or more dropped PDUs or one or more delayed PDUs corresponding to the one or more respective data flows; and
sending, to a first network element, a traffic notification message indicating the one or more dropped PDUs identified or the one or more delayed PDUs identified.

2. The method of claim 1, wherein the monitoring request configuration further comprises at least one of:
a delay threshold value for identifying the one or more dropped PDUs or the one or more delayed PDUs, wherein the delay threshold value is time value equal to or greater than zero;
a reporting period for sending the traffic notification message; or
one or more traffic notification message information fields to be included in the traffic notification message.

3. The method of claim 2, wherein the one or more traffic notification message information fields comprises at least one of: PDU information indicating the one or more dropped PDUs or the one or more delayed PDUs, a cause value corresponding to the respective one or more dropped PDUs or the one or more delayed PDUs, a protocol for sending the traffic notification message, a first network element identification, or a second element identification.

4. The method of claim 3, wherein the monitoring request configuration further comprises at least one of: a packet delay budget (PDB), or a PDU set delay budget (PSDB).

5. The method of claim 4, wherein the PDU information comprises at least one of:
an indication of how long delivery of each PDU of the one or more dropped PDUs or one or more delayed PDUs was delayed beyond the PDB; or
an indication of how long delivery of a respective PDU of the one or more dropped PDUs or one or more delayed PDUs or a respective PDU set of the one or more dropped PDUs or one or more delayed PDUs was delayed beyond the PSDB.

6. The method of claim 4, wherein identifying the one or more dropped PDUs or the one or more delayed PDUs is based on a determined cause, the determined cause comprising at least one of:
determining a respective PDU cannot be delivered within the PDB;
determining a respective PDU or a respective PDU set cannot be delivered within the PSDB;
determining, with a PDU set integrated handling indication (PSIHI) is enabled, that a PDU of a same PDU set has been discarded;
determining that a PDU of a same PDU set has been discarded and discarding the PDU will not decrease a PDU set error rate (PSER) of the same PDU;
determining, based on an application layer forward error correction (AL-FEC) PDU set discard ratio, a PDU can be discarded because enough PDUs of a same PDU set have been delivered;
determining to transmit a PDU knowing the PDU cannot be delivered within the PDB;
determining to transmit a PDU knowing the PDU set the PDU belongs to cannot be delivered within the PSDB;
determining to transmit a PDU while PSHI is enabled knowing a PDU of a same PDU set has been discarded;
determining to transmit a PDU knowing, based on an AL-FEC PDU Set Discard Ratio, that a PDU is discarded because enough PDUs of a same PDU set have been delivered; or
determining to drop a PDU based on congestion at the RAN.

7. The method of claim 6, wherein the cause value corresponds to the determined cause.

8. The method of claim 3, wherein the monitoring request configuration further comprises at least one of:
a respective priority of one or more PDUs associated with the one or more respective data flows;
a respective priority of a PDU set comprising the one or more PDUs associated with the one or more respective data flows;
a quality of service (QoS) flow of one or more PDUs associated with the one or more respective data flows; and
a service data flow (SDF) of one or more PDUs associated with the one or more respective data flows; or
a multiplexed stream of one or more PDUs associated with the one or more respective data flows.

9. The method of claim 8, further comprising: determining to send the traffic notification message indicating the one or more dropped PDUs identified or the one or more delayed PDUs identified based on at least one of:
the respective priority of the of one or more PDUs associated with the one or more respective data flows;
the respective priority of the PDU set comprising the one or more PDUs associated with the one or more respective data flows;
the QoS flow of the one or more PDUs associated with the one or more respective data flows;
the SDF of the one or more PDUs associated with the one or more respective data flows; or
the multiplexed stream of the one or more PDUs associated with the one or more respective data flows.

10. A radio access node (RAN) comprising:
processor circuitry; and
a transceiver communicatively coupled with the processor circuitry and configured to receive a monitoring request configuration identifying one or more respective data flows requiring a traffic notification indicating a dropped packet data unit (PDU) or a delayed PDU;
the processor circuitry configured to identify one or more dropped PDUs or one or more delayed PDUs corresponding to the one or more respective data flows; and
the transceiver configured to send, to a first network element, a traffic notification message indicating the one or more dropped PDUs identified or the one or more delayed PDUs identified.

11. The RAN of claim 10, wherein the monitoring request configuration further comprises at least one of:
a delay threshold value for identifying the one or more dropped PDUs or the one or more delayed PDUs, wherein the delay threshold value is time value equal to or greater than zero;
a reporting period for sending the traffic notification message; or
one or more traffic notification message information fields to be included in the traffic notification message.

12. The RAN of claim 11, wherein the one or more traffic notification message information fields comprises at least one of: PDU information indicating the one or more dropped PDUs or the one or more delayed PDUs, a cause value corresponding to the respective one or more dropped PDUs or the one or more delayed PDUs, a protocol for sending the traffic notification message, a first network element identification, or a second element identification.

13. The RAN of claim 12, wherein the monitoring request configuration further comprises at least one of: a packet delay budget (PDB), or a PDU set delay budget (PSDB).

14. The RAN of claim 13, wherein the PDU information comprises at least one of:
an indication of how long delivery of each PDU of the one or more dropped PDUs or one or more delayed PDUs was delayed beyond the PDB; or
an indication of how long delivery of a respective PDU of the one or more dropped PDUs or one or more delayed PDUs or a respective PDU set of the one or more dropped PDUs or one or more delayed PDUs was delayed beyond the PSDB.

15. The RAN of claim 14, wherein the processor circuitry is configured to identify the one or more dropped PDUs or the one or more delayed PDUs based on a determined cause, the determined cause comprising the processor circuitry configured to determine at least one of:
a respective PDU cannot be delivered within the PDB;
a respective PDU or a respective PDU set cannot be delivered within the PSDB;
a PDU of a same PDU set has been discarded while a PDU set integrated handling indication (PSIHI) is enabled;
a PDU of a same PDU set has been discarded and discarding the PDU will not decrease a PDU set error rate (PSER) of the same PDU;
a PDU can be discarded because enough PDUs of a same PDU set have been delivered based on an application layer forward error correction (AL-FEC) PDU set discard ratio;
to transmit a PDU knowing the PDU cannot be delivered within the PDB;
to transmit a PDU knowing the PDU set the PDU belongs to cannot be delivered within the PSDB;
to transmit a PDU knowing while PSHI is enabled knowing a PDU of a same PDU set has been discarded;
to transmit a PDU knowing, based on an AL-FEC PDU set discard ratio, that a PDU is discarded because enough PDUs of a same PDU set have been delivered; or
to drop a PDU based on congestion at the RAN.

16. The RAN of claim 15, wherein the cause value corresponds to the determined cause.

17. The RAN of claim 12, wherein the monitoring request configuration further comprises at least one of:
a respective priority of one or more PDUs associated with the one or more respective data flows;
a respective priority of a PDU set comprising the one or more PDUs associated with the one or more respective data flows;
a quality of service (QoS) flow of one or more PDUs associated with the one or more respective data flows; and
a service data flow (SDF) of one or more PDUs associated with the one or more respective data flows; or
a multiplexed stream of one or more PDUs associated with the one or more respective data flows.

18. The RAN of claim 17, wherein the processor circuitry is further configured to: determine to send the traffic notification message indicating the one or more dropped PDUs identified or the one or more delayed PDUs identified based on at least one of:
the respective priority of the of one or more PDUs associated with the one or more respective data flows;
the respective priority of PDU set comprising the one or more PDUs associated with the one or more respective data flows;
the QoS flow of the one or more PDUs associated with the one or more respective data flows;
the SDF of the one or more PDUs associated with the one or more respective data flows; or
the multiplexed stream of the one or more PDUs associated with the one or more respective data flows.
